(19) United States
(12) Patent Application Publication
(10) Pub. No.: US 2010/0254873 A1
(43) Pub. Date: Oct. 7, 2010

(54) Methods of Use for Lime Residuals

(76) Inventors: James H. Irvine, Cincinnati, OH (US); John N. Seibel, Crestview Hills, KY (US); Linda B. Seibel, Crestview Hills, KY (US)

Correspondence Address: DINSMORE & SHOHL LLP, 1900 CHEMED CENTER, 255 EAST FIFTH STREET, CINCINNATI, OH, 45202, US

(21) Appl. No.: 12/416,587

(22) Filed: Apr. 1, 2009

(51) Int. Cl. B01D 53/48

(52) U.S. Cl. 423/244.07

(57) ABSTRACT

Disclosed is a method of using lime residuals from a water treatment plant that includes collecting lime residuals from a water treatment plant, transporting the lime residuals to a power plant, pumping the lime residuals into a limestone slurry storage tank and utilizing the lime residuals in a flue gas desulphurization process.

### TECHNICAL FIELD

The invention relates to methods of use for lime residuals, and in particular, methods of use for water softening lime residuals within flue gas desulphurization systems.

### BACKGROUND

Water treatment plants that utilize lime to remove the hardness from a water source often generate large quantities of lime residuals. There are costs associated with the disposal of such lime residuals as industrial waste. Accordingly, beneficial uses for lime residuals are of continued interest.

### SUMMARY

One embodiment of a method of using lime residuals from a water treatment plant includes collecting lime residuals from a water treatment plant, transporting the lime residuals to a power plant, pumping the lime residuals into a limestone slurry storage tank and utilizing the lime residuals in a flue gas desulphurization process.

Another embodiment of a method of using lime residuals from a water treatment plant includes collecting lime residuals from a water treatment plant, wherein the lime residuals are collected in a slurry form from a lime residual slurry discharge stream; transporting the lime residuals to a power plant; pumping the lime residuals into a limestone slurry storage tank; and utilizing the lime residuals in a flue gas desulphurization process.

Another embodiment of a method of using lime residuals from a water treatment plant includes collecting lime residuals from a water treatment plant, wherein the lime residuals are collected in a slurry form from a temporary storage lagoon; transporting the lime residuals to a power plant; pumping the lime residuals into a limestone slurry storage tank; and utilizing the lime residuals in a flue gas desulphurization process.

These and additional features can be more fully understood in view of the following detailed description.

### DETAILED DESCRIPTION

### Water Treatment Plant System:

Water treatment plants may utilize lime, a.k.a. quicklime, to soften a water source by removing calcium and/or magnesium hardness. The water source may be acquired from any known supply, including surface water from rivers and lakes and ground water from wells. Before introduction to the water source, the lime (CaO) may be hydrated to form a lime slurry. This hydration process is often referred to as “slaking,” and is summarized as follows:

CaO+H₂O→Ca(OH)₂

The lime slurry (Ca(OH)₂) may then be introduced to the water source for softening. Upon introduction, calcium and/or magnesium may be removed from the water source, summarized by the following reactions:

Ca(OH)_{2 l +Ca(HCO}₃)₂→2CaCO₃+2H₂O

Ca(OH)₂+Mg(HCO₃)₂→MgCaCO₃+CaCO₃+2H₂O

Ca(OH)₂+MgCO₃→Mg(OH)₂+CaCO₃

Accordingly, the byproduct of the interaction between the lime slurry and the water source is a lime residual that may comprise calcium carbonate (CaCO₃), magnesium carbonate (MgCaCo₃) and magnesium hydroxide (Mg(OH)₂). Further elements may also be precipitated from the water source, including, but not limited to, iron and aluminum. As a result, the lime residual may also contain residues from any iron and/or aluminum coagulation, colloidal particles and unreacted lime. In addition, because water softening processes are preferably conducted at a pH range of about 9.0 to about 11.0, and more preferably at about a pH of 10.5, free lime (Ca⁺⁺+2OH⁻) may also exist in the lime residual. However, the characteristics of the water source and lime slurry will determine the particular composition of a lime residual.

In some water treatment plants, the lime residual from a water softening process is directly discharged back into an untreated water source (e.g., a stream). In other water treatment plants, the lime residual is fed into one or more temporary storage lagoons. Upon reaching capacity, the temporary storage lagoons may be dredged, and lime residual solids stockpiled for disposal. Disposal often includes deposit of the lime residual solids in a monofill.

### Flue Gas Desulphurization System:

Power plants may utilize limestone to remove sulfur dioxide (SO₂) from flue gas emissions in a process known as flue gas desulphurization. In such a system, finely ground limestone, which is largely composed of calcium carbonate, is mixed with water to form a limestone slurry and stored in a limestone slurry storage tank. The limestone slurry is sprayed to contact flue gas traveling through one or more scrubber towers. The contact between the flue gas and the limestone slurry spray cools and saturates the flue gas and results in absorption of the sulfur dioxide into the limestone slurry. The limestone slurry subsequently falls to the bottom of the scrubber tower(s) and drains into one or more reaction tanks. Chemical reactions between the calcium carbonate from the limestone slurry and the absorbed sulfur dioxide result in the precipitation of solid particles of calcium sulfite (CaSO₃) and calcium sulfate (CaSO₄) within the reaction tank(s).

Accordingly, when the flue gas contacts the limestone slurry spray in the scrubber tower(s), sulfur dioxide is transferred from the gas phase to the liquid phase. This process is summarized as follows:

SO₂+H₂O [symbol] H₂SO_{3(aq)}

H₂SO_{3(aq)} [symbol] H⁺_{(aq)}+HSO₃⁻_{(aq)}

The acidity generated by this process may help to dissolve the finely ground limestone particles. The dissolving of the limestone is summarized as follows:

CaCO_{3(aq)}+H⁺_{(aq)} [symbol] Ca⁺⁺_{(aq)}+HCO_{3(aq)}

The dissolved calcium may then react with the sulfur species to form calcium sulfite, which precipitates as a hemihydrate (CaSO₃.½H₂O). The reaction that forms calcium sulfite is as follows:

Ca⁺⁺_{(aq)}+HCO₃⁻_{(aq)}+HSO₃⁻_{(aq)}→CaSO_{3(aq)}+CO₂+H₂O

However, because calcium sulfite hemihydrate may be difficult to dewater, some flue gas desulphurization systems blow air into the reaction tank(s). The addition of air into the reaction tank(s) produces sulfate ions (SO₄⁻²) by the following process:

HSO₃⁻+½O₂→SO₄⁻²+H⁺

Sulfate ions may react with calcium ions to form calcium sulfate, which precipitates as calcium sulfate dihydrate, a.k.a., gypsum (CaSO₄2H₂O). The reaction that forms calcium sulfate is as follows:

Ca⁺⁺_{(aq)}+HCO₃⁻_{(aq)}+H⁺+SO₄⁻²_{(aq)}→CaSO_{4(aq)}+CO₂+H₂O

Gypsum is easier to dewater and handle than calcium sulfite hemihydrate, and may be utilized as a beneficial byproduct of the flue gas desulphurization system, for example, as a material utilized in the production of drywall.

### Utilization of Lime Residuals in Flue Gas Scrubber Towers:

Limestone considered desirable for use in flue gas desulphurization systems typically has a composition of 95 percent or greater calcium carbonate, with the balance comprising magnesium carbonate, manganese carbonate, iron, silicon oxide compounds and/or inert compounds. Lime residuals from water treatment plants often have a composition of 90 percent or greater calcium carbonate, with the balance comprising magnesium carbonate, magnesium hydroxide, iron coagulations, aluminum coagulations, colloidal particles, unreacted lime and/or free lime. As a result, it has been discovered that power plants may utilize the lime residuals from water treatment plants in flue gas desulphurization processes.

Accordingly, lime residuals from a water treatment plant may be added in slurry form into a limestone slurry storage tank of a power plant and utilized in flue gas desulphurization processes. The lime residuals from the water treatment plant may be prepared and/or delivered to the power plant utilizing various methods. In a first method, a lime residual sludge may be dredged from a temporary storage lagoon or obtained from stockpiled lime residual solids. Because many flue gas desulphurization systems operate optimally with a limestone slurry that has 20-50% solids, the lime residual sludge or solids may first need to be hydrated to such a consistency before addition to the limestone slurry storage tank. To obtain this composition, water may be added to the sludge or solids at the water treatment center to form a lime residual slurry to transport to the power plant. Alternately, the sludge or solids may be transported to the power plant and then hydrated into a slurry form. In one embodiment, the lime residual slurry added to the limestone slurry storage tank contains between 20-50% solids. In another embodiment, the lime residual slurry added to the limestone slurry storage tank contains between 30-35% solids. Transport may employ any method or vehicle known in the art, including, but not limited to, trucks, trains, ships and barges. At the power plant, a pump may be utilized to unload the prepared lime residual slurry into the limestone slurry storage tank.

In a second method, the lime residuals may be directly delivered from the water treatment plant to the power plant in slurry form. The lime residual slurry may be taken directly from the lime residual slurry discharge stream of the water treatment plant, or may be pumped out of the temporary storage lagoon. To obtain the desired composition for the gas desulphurization process, water may be added to or subtracted from the slurry at the water treatment center before transport to the power plant. Alternately, the slurry may be transported to the power plant and then hydrated or dewatered. In some embodiments, the lime residual slurry leaving the water softening process is already of a proper consistency for the flue gas desulphurization process. The transport of the lime residual slurry may employ any method or vehicle known in the art, including, but not limited to, trucks, trains, ships, barges or long range piping systems. As before, a pump may be utilized to unload the lime residual slurry into the limestone slurry storage tank. This method of use may reduce and/or eliminate the step of hydrating the lime residuals from a sludge or solid composition before use in the flue gas desulphurization process. In addition, this method of use may allow for the continuous transport of lime residuals to the power plant, and therefore, remove the necessity of a temporary storage lagoon at the water treatment plant.

In utilizing any method of preparation and/or delivery, the quality of the lime residuals may benefit from the introduction of CO₂. As previously detailed, because water softening processes are preferably conducted at a pH that is basic, an amount of free lime (Ca⁺⁺+2OH⁻) may also exist in the lime residual. Free lime present in the lime residual slurry may present a problem in the flue gas desulphurization process, as free lime tends to scale piping, absorbers and other components. However, the introduction of CO₂ to the lime residuals may convert at least a portion of the free lime to calcium carbonate. The reaction is as follows:

Ca⁺⁺+2OH⁻+CO₂→CaCO₃+H₂O

CO₂ may be introduced to the lime residuals while being stored as a slurry or sludge in a temporary storage lagoon. Accordingly, CO₂ may be absorbed from the atmosphere over a period of time to convert at least a portion of the free lime to calcium carbonate. In some embodiments, the period of time for appropriate free lime conversion may be between two hours and five weeks. In one particular embodiment, the period is three days. In another particular embodiment, that period is five days.

In another method of converting free lime to calcium carbonate, CO₂ may be introduced to the lime residuals through utilization of a sparger. In some embodiments of this method of CO₂ introduction, the lime residual slurry may be contained in a tall, agitated tank with a sparger at the bottom of the tank for introducing CO₂ bubbles.

In addition to the economic and environmental benefit of using an industrial waste for a beneficial purpose, further benefits may also be realized from the preceding methods of use. Due to the smaller particle size in comparison with pulverized limestone, the lime residuals offer better reactivity with sulfur dioxide in the flue gas desulphurization process. The gypsum byproduct produced by a flue gas desulphurization process utilizing lime residuals comprises improved quality (particle size, etc.) for the production of drywall. Additionally, embodiments of the methods disclosed above may eliminate the need to utilize temporary storage lagoons and monofills. The elimination of temporary storage lagoons and monofills leads to more unencumbered real estate, less maintenance and further economic benefit.

While particular embodiments and aspects of the present invention have been described herein, various other changes and modifications can be made without departing from the spirit and scope of the invention. Moreover, although various inventive aspects have been described herein, such aspects need not be utilized in combination. It is therefore intended that the appended claims cover all such changes and modifications that are within the scope of this invention.

1. A method of using lime residuals from a water treatment plant comprising:
collecting lime residuals from a water treatment plant;
transporting the lime residuals to a power plant, wherein the lime residuals are directly delivered from the water treatment plant to the power plant in slurry form;
pumping the lime residuals into a limestone slurry storage tank; and
utilizing the lime residuals in a flue gas desulphurization process.

2. The method of claim 1, wherein the lime residuals are collected from the water treatment plant in a slurry form from a lime residual slurry discharge stream.

3. The method of claim 2, wherein lime residuals are transported to the power plant by one or more trucks.

4. The method of claim 2, further comprising introducing CO₂ to the lime residuals.

5. The method of claim 4, wherein the CO₂ is introduced through a sparger.

6. The method of claim 2, wherein the collecting lime residuals from a water treatment plant and transporting the lime residuals to a power plant is on a continuous basis such that a temporary storage lagoon is not used at the water treatment plant.

7. The method of claim 1, wherein the lime residuals are collected from the water treatment plant in a slurry form from a temporary storage lagoon.

8. The method of claim 7, wherein lime residuals are transported to the power plant by one or more trucks.

9. The method of claim 7, wherein the lime residuals are contained in the temporary storage lagoon for a period of at least three days.

10. The method of claim 1, wherein the lime residuals are collected from the water treatment plant in a sludge form by dredging a temporary storage lagoon or collected by obtaining stockpiled solids.

11. The method of claim 10, wherein lime residuals are transported to the power plant by one or more trucks.

12. The method of claim 10, wherein the lime residuals were contained in the temporary storage lagoon for a period of at least three days.

13. The method of claim 10, wherein the lime residuals are hydrated into a slurry form before being transported to the power plant.

14. The method of claim 10, wherein the lime residuals are hydrated into a slurry form after being transported to the power plant.

15. A method of using lime residuals from a water treatment plant comprising:
collecting lime residuals from a water treatment plant, wherein the lime residuals are collected in a slurry form from a lime residual slurry discharge stream;
transporting the lime residuals to a power plant, wherein the lime residuals are directly delivered from the water treatment plant to the power plant in slurry form;
pumping the lime residuals into a limestone slurry storage tank; and
utilizing the lime residuals in a flue gas desulphurization process.

16. The method of claim 15, wherein lime residuals are transported to the power plant by one or more trucks.

17. The method of claim 15, further comprising introducing CO₂ to the lime residuals.

18. The method of claim 17, wherein the CO₂ is introduced through a sparger.

19. A method of using lime residuals from a water treatment plant comprising:
collecting lime residuals from a water treatment plant, wherein the lime residuals are collected in a slurry form from a temporary storage lagoon;
transporting the lime residuals to a power plant, wherein the lime residuals are directly delivered from the water treatment plant to the power plant in slurry form;
pumping the lime residuals into a limestone slurry storage tank; and
utilizing the lime residuals in a flue gas desulphurization process.

20. The method of claim 19, wherein the lime residuals are contained in the temporary storage lagoon for a period of at least three days.
